(19) United States
(12) Patent Application Publication
(10) Pub. No.: US 2020/0190403 A1
(43) Pub. Date: Jun. 18, 2020

(54) QUANTUM DOT WITH METASTABLE PHASE AND MANUFACTURING METHOD FOR THE SAME

(71) Applicant: KOREA ADVANCED INSTITUTE OF SCIENCE AND TECHNOLOGY, Daejeon (KR)

(72) Inventors: Keonjae Lee, Daejeon (KR); Duk Young Jeon, Daejeon (KR); Hu Young Jeong, Daejeon (KR); Tae Hong Im, Daejeon (KR); Chulhee Lee, Daejeon (KR)

(21) Appl. No.: 16/226,038

(22) Filed: Dec. 19, 2018

(30) Foreign Application Priority Data
Dec. 14, 2018 (KR) 10-2018-0162132

(51) Int. Cl. C09K 11/62; B01J 19/12

(52) U.S. Cl. CPC C09K 11/623; B82Y 20/00; B01J 19/122

(57) ABSTRACT

The present invention relates to a quantum dot containing a metastable phase which contains at least partly a crystal structure at quantum dot synthesis temperature at room temperature.

### CROSS-REFERENCE TO RELATED APPLICATION

This application claims priority of Korean Patent Application No. 10-2018-0162132, filed on Dec. 14, 2018, in the KIPO (Korean Intellectual Property Office), the disclosure of which is incorporated herein entirely by reference.

### BACKGROUND OF THE INVENTION

### Field of the Invention

The present disclosure relates to a quantum dot with a metastable phase and a method for manufacturing the same, more particularly to a quantum dot with a metastable phase, exhibiting high efficiency by maintaining crystalline defect high, and a method for manufacturing the same.

### Description of the Related Art

A quantum dot is a semiconductor nanoparticle having a size of several to more than ten nanometers. It emits energy of various wavelengths because its band gap energy is controlled by the size of the quantum dot due to the quantum confinement effect. The light emission wavelengths of the quantum dot ranges from visible to infrared and ultraviolet regions and exhibits very high color purity with an emission width of tens of nanometers. For this reason, when used for an LED (light-emitting diode), it enables emission of light of various colors and can realize white LED.

Korean Patent Application No. 10-2008-70158726 discloses a method for synthesizing a quantum dot using a laser. However, a method of synthesizing a quantum dot with high efficiency by directly applying light energy to a bulk solution has not been disclosed.

In particular, common binary quantum dots (InP, CdSe, CdS, etc.) emit photons having energy corresponding to the band gap energy difference of the conduction band and the valence band based on the quantum confinement effect. This is called band-to-band recombination.

When the photons corresponding to the band gap energy are emitted, quantum efficiency is decreased if there is a defect level interrupting the band-to-band recombination. It is of great importance to remove the crystalline defect in the crystal in order to maximize the quantum efficiency by preventing this phenomenon.

However, contrarily to the binary quantum dots, ternary or quaternary quantum dots exhibit increased quantum efficiency when there is a defect level due to the presence of a crystalline defect.

That is to say, the multi-component quantum dot undergoes radiative recombination between the defect donor level generated closely to the conduction band edge and the defect acceptor level generated closely to the valence band edge, rather than emission by band-to-band recombination. This is called donor-acceptor pair recombination.

Accordingly, for multi-component quantum dots consisting of three or more components, it is important to increase the frequency of donor-acceptor pair recombination by maintaining crystal structure and crystalline defect to some degree. However, a method for synthesizing a high-efficiency quantum dot while maintaining crystalline defect to some degree has not been disclosed yet.

### SUMMARY OF THE INVENTION

The present disclosure is directed to providing a quantum dot maintaining crystalline defect to some degree even at room temperature and a method for synthesizing the same economically.

The present disclosure provides a quantum dot containing a metastable phase which contains at least partly a crystal structure at quantum dot synthesis temperature at room temperature.

In an exemplary embodiment of the present disclosure, the synthesis temperature exceeds the room temperature and the crystal structure at the quantum dot synthesis temperature contains more crystalline defect associated with improvement of emission characteristics as compared to the crystal structure in equilibrium at the room temperature.

In an exemplary embodiment of the present disclosure, the quantum dot is a multi-component quantum dot of at least three components.

In an exemplary embodiment of the present disclosure, the quantum dot is synthesized in a solution by irradiating light several times in a pulse manner with a time width of 0.1-100 ms.

In an exemplary embodiment of the present disclosure, the light is irradiated from a full-wavelength flash lamp.

The present disclosure also provides a method for synthesizing a quantum dot, including: a step of preparing a precursor solution in which a quantum dot precursor component is dissolved; and a step of synthesizing a quantum dot in the solution by irradiating light to the precursor solution several times with a time width of 0.1-100 ms.

In an exemplary embodiment of the present disclosure, the synthesized quantum dot contains at least partly a crystal phase in the step of irradiating light several times even at room temperature and the temperature in the step of irradiating light several times exceeds the room temperature.

In an exemplary embodiment of the present disclosure, the quantum dot is a multi-component quantum dot of at least three components and the light is irradiated from a full-wavelength flash lamp.

According to the present disclosure, a quantum dot of a metastable phase which maintains at least partly a crystal phase at the high temperature (exceeding room temperature) during the synthesis even at room temperature by introducing a thermal non-equilibrium synthesis process and, thereby, the efficiency of the quantum dot may be improved effectively by maintaining crystalline defect high.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a metastable phase according to the present disclosure.

FIG. 2 is a schematic view illustrating a process of preparing a high-efficiency light-emitting quantum dot of a metastable phase wherein a metal element is doped in the host quantum dot in a thermal non-equilibrium state according to an exemplary embodiment of the present disclosure.

FIG. 3 illustrates high quantum efficiency of a metastable phase.

FIGS. 4A and 4B show images of a zinc element-doped quaternary In2S3 quantum dot as a comparative example (traditional hydrothermal synthesis, FIG. 4A) and a quantum dot synthesized according to an example of the present disclosure (synthesis by ultrafast flash lamp, FIG. 4B).

FIG. 5 shows a result of comparing the average quantum efficiency (PLQY) of a metastable phase quantum dot synthesized in an example with a quantum dot prepared by traditional hydrothermal synthesis.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

In the present disclosure, light is irradiated several times in a pulse manner to a synthesis solution containing the constitutional elements of a quantum dot using a flash lamp emitting light of full-wavelength ranges (from UV to NIR), which has an ultrafast pulse duration of tens of milliseconds (ms) or shorter, i.e., several to tens of ms.

By introducing a thermal non-equilibrium synthesis process using instant photothermal treatment/quenching for a very short time, rather than the traditional thermal synthesis conducted under a thermal equilibrium state, a quantum dot of a metastable phase, which maintains at least partly a crystal phase at the high temperature (exceeding room temperature) during the synthesis even at the room temperature, can be prepared.

In addition, the quantum dot containing at least partly a crystal phase at the high synthesis temperature, not a phase in equilibrium at room temperature, has high crystalline defect than the quantum dot prepared by the common hydrothermal synthesis method. As a result, the efficiency of the multi-component quantum dot of three or more components, doped with a metal element (Ag, Zn, Mg, etc.), may be increased effectively.

A method for synthesizing a quantum dot according to an exemplary embodiment of the present disclosure includes: a step of preparing a precursor solution in which a quantum dot precursor component is dissolved; and a step of synthesizing a quantum dot in the solution by irradiating light to the precursor solution several times with a time width of 0.1-100 ms. The quantum dot according to the present disclosure has a metastable phase maintaining the crystal phase during the instant heating even at room temperature, rather than the phase in equilibrium at room temperature. The high crystalline defect of the metastable phase improves the efficiency of the quantum dot.

In an exemplary embodiment of the present disclosure, a precursor solute containing at least three elements constituting the quantum dot and a polymer solvent are prepared into a homogeneous solution and then the quantum dot is synthesized by irradiating ultrafast (0.1-100 ms) light creating a thermal non-equilibrium environment in a pulse manner. In particular, the quantum dot is synthesized in a thermal non-equilibrium state by the ultrafast light in a pulse manner.

In an exemplary embodiment of the present disclosure, the precursor solution may contain at least three components of transition metals/boron group/lanthanides including group 3-13 elements exhibiting cationic property (silver, iridium, copper, tin, indium, dysprosium, etc.) and group 15 elements (phosphorus, arsenic, antimony, etc.) and group 16 chalcogens (oxygen, sulfur, tellurium, etc.) exhibiting anionic property as the precursor solute. In particular, as compared to the stable phase which is in equilibrium at room temperature, the donor-acceptor pair recombination effect is maximized by introducing the metastable phase when has more crystalline defect enhancing quantum efficiency at room temperature.

Hereinafter, the metastable phase according to the present disclosure is described in more detail.

Most of light-emitting quantum dots consist of regularly arranged elements and atoms, which are called unit cells. When the unit cells are arranged in numerous numbers, it is called a crystal structure and a structurally very stable phase occurs in a specific temperature range. The components constituting the crystal structure form the stable phase in the early stage of synthesis depending on the synthesis temperature. The phase is maintained because it is thermodynamically the most stable structure in the temperature range. The temperature range in which a specific phase is maintained varies depending on the components constituting the material, stoichiometric compositional ratios thereof and the type of the finally synthesized material and is determined by the phase diagram of the material.

Accordingly, when synthesizing a material having a specific phase, even when the synthesis is conducted at a thermodynamically stable temperature, if the temperature range (T₁) capable of maintaining the stable phase deviates slowly from the thermal equilibrium state, a phase transition occurs at the new temperature range (T₂) to form a stable crystal structure. For example, assume that an α-phase quantum dot maintaining a stable phase at relatively high temperature, i.e., the synthesis temperature, is synthesized. If the temperature range capable of maintaining the crystal structure of α-phase (including the synthesis temperature) is higher than room temperature, when the temperature of the synthesized quantum dot is lowered from the thermal equilibrium to room temperature, the α-phase is not maintained and phase transition occurs to β-phase for a predetermined time.

However, if the α-phase quantum dot is synthesized very quickly at the high temperature and enough time for phase transition to the β-phase is not allowed, the crystal structure can be maintained even at the temperature where the α-phase cannot be maintained stable. Because the synthesis of the α-phase quantum dot was not conducted in a thermal non-equilibrium state, a structurally unstable quantum dot in metastable phase is prepared.

Accordingly, because the quantum dot according to the present disclosure is synthesized very quickly, it may contain the crystal phase during the synthesis (the crystal phase at the synthesis temperature) at least partly even at room temperature. This crystal phase has more crystalline defect as compared to the crystal phase which is in equilibrium at room temperature.

FIG. 1 illustrates a metastable phase according to the present disclosure.

Referring to FIG. 1, according to the traditional thermal synthesis of synthesizing a quantum dot in thermal equilibrium state, a stable phase maintained at room temperature is synthesized because the structure of the quantum dot synthesized at relatively high temperature cannot be maintained at room temperature. However, in the present disclosure, in order to prepare a quantum dot of a metastable phase which cannot be prepared by the traditional thermal synthesis, i.e., a phase containing at least partly the crystal phase during the synthesis at high temperature, high temperature heat treatment and quenching are conducted instantly in very short time of tens of milliseconds or shorter. For this, a high-energy flash lamp irradiating full-wavelength light is used to synthesize a metal element-doped light-emitting quantum dot containing at least two elements and exhibiting a crystal structure in metastable phase.

In particular, because the quantum dot can be synthesized only when high light energy is irradiated uniformly over a large area within very short times of tens of milliseconds or shorter, it is preferred to use the flash lamp with a large wavelength range rather than a laser characterized by short wavelength and local heat treatment.

During the process of irradiating ultrafast pulsed light several times to the precursor solution in thermal non-equilibrium state according to the present disclosure, spontaneous quenching is conducted after the heat treatment. Therefore, the size, chemical composition, etc. of the intermediates (host material, doped material, etc.) synthesized in each pulse range can be investigated precisely and the appropriate number of irradiation and reaction time can be controlled, which are impossible in the traditional thermal synthesis.

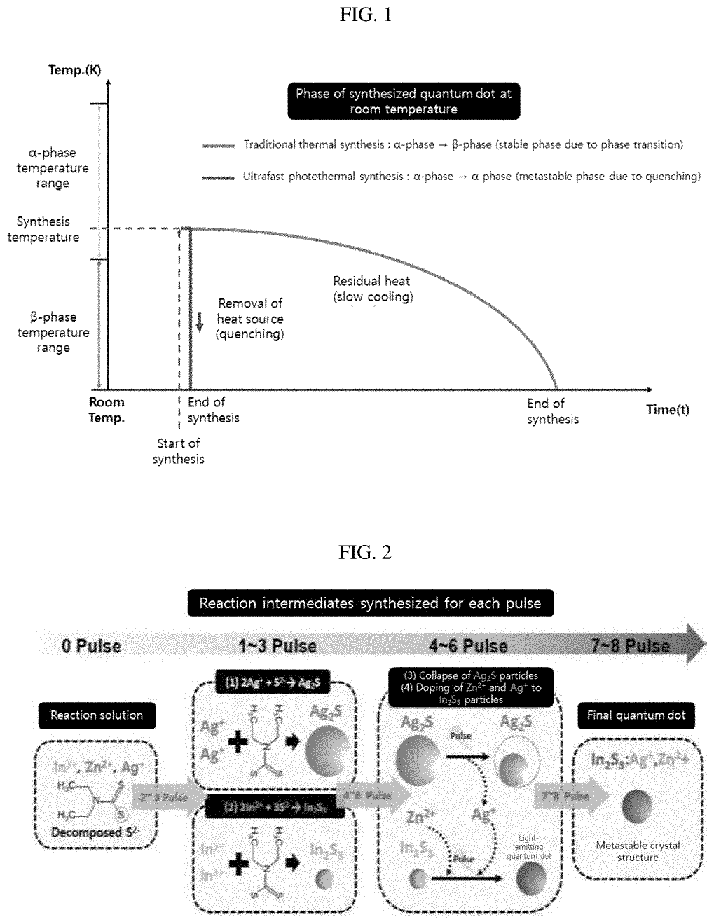

FIG. 2 is a schematic view illustrating a process of preparing a high-efficiency light-emitting quantum dot of a metastable phase wherein a metal element is doped in the host quantum dot in a thermal non-equilibrium state according to an exemplary embodiment of the present disclosure.

Referring to FIG. 2, when ultrafast photothermal energy in the level of milliseconds is irradiated several times to a reaction solution containing indium, silver, sulfur and zinc, Ag₂S and In₂S₃ clusters with a size of 10 nm or smaller are formed in the solution as reaction intermediates while 1-3 pulse(s) are applied.

Then, as several pulses are applied sequentially to the solution, silver ion produced from the structural collapse of the reaction intermediate Ag₂S by heat and zinc ion contained in the solution are doped on the surface of In₂S₃. Finally, silver- and zinc-doped AgZn:In₂S₃ is synthesized when 7-8 pulses are applied. Accordingly, the present disclosure is also advantageous in that a quantum dot of optimized composition can be synthesized by varying the number of pulses.

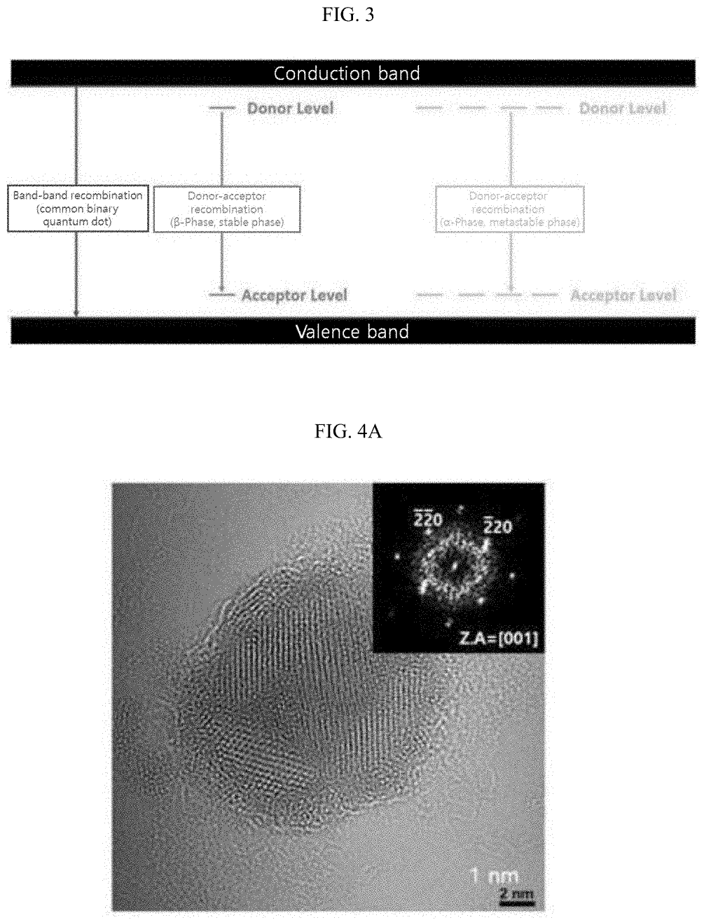

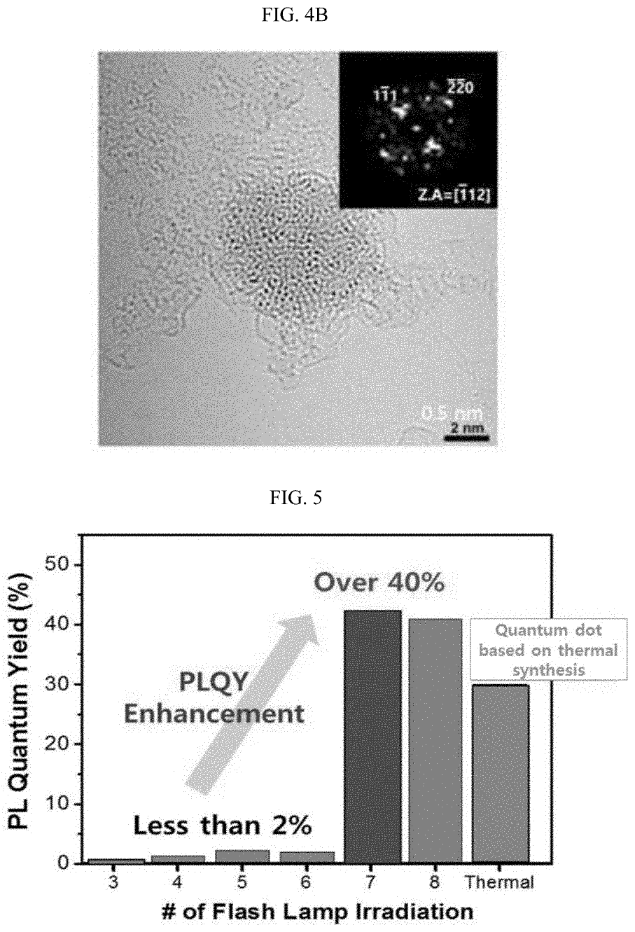

FIG. 3 illustrates high quantum efficiency of a metastable phase and FIGS. 4A and 4B show images of a zinc element-doped quaternary In₂S₃ quantum dot as a comparative example (traditional hydrothermal synthesis, FIG. 4A) and a quantum dot synthesized according to an example of the present disclosure (synthesis by ultrafast flash lamp, FIG. 4B).

Referring to FIGS. 3, 4A and 4B, it can be seen that a silver- and zinc-doped quaternary In₂S₃ quantum dot synthesized using an ultrafast flash lamp according to the present disclosure has a metastable structure (defect cubic structure, α-phase) of In₂S₃ at room temperature, not the stable structure (tetragonal structure, β-phase) of In₂S₃ at room temperature, which is obtained by the traditional thermal synthesis in equilibrium state.

Because the metastable structure (α-phase) is relatively rich in crystalline defect at room temperature as compared to the stable structure (β-phase), the quantum efficiency is increased due to high possibility of donor-acceptor pair recombination.

Referring to FIGS. 4A and 4B, whereas the quantum dot prepared by thermal synthesis for a long time exhibits high crystallinity and a stable structure (β-phase, FIG. 4a), the quantum dot prepared by photothermal synthesis according to the present disclosure shows a metastable structure (α-phase, FIG. 4b) and also shows higher quantum efficiency.

Referring to FIG. 5, it can be seen that the In₂S₃ quantum dot having a metastable structure prepared according to an exemplary embodiment of the present disclosure exhibits high quantum efficiency (photoluminescence quantum yield) as compared to the quantum dot synthesized by the traditional thermal synthesis.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A quantum dot comprising a metastable phase which comprises at least partly a crystal structure at quantum dot synthesis temperature at room temperature.

2. The quantum dot of claim 1, wherein the synthesis temperature exceeds the room temperature.

3. The quantum dot of claim 1, wherein the crystal structure at the quantum dot synthesis temperature comprises more crystalline defect associated with improvement of emission characteristics as compared to the crystal structure in equilibrium at the room temperature.

4. The quantum dot of claim 3, wherein the quantum dot is a multi-component quantum dot of at least three components.

5. The quantum dot of claim 1, wherein the quantum dot is synthesized in a solution by irradiating light several times in a pulse manner with a time width of 0.1-100 ms.

6. The quantum dot of claim 5, wherein the light is irradiated from a full-wavelength flash lamp.

7. A method for synthesizing a quantum dot, comprising:
preparing a precursor solution in which a quantum dot precursor component is dissolved; and
synthesizing a quantum dot in the solution by irradiating light to the precursor solution several times with a time width of 0.1-100 ms.

8. The method for synthesizing a quantum dot of claim 7, wherein the synthesized quantum dot comprises at least partly a crystal phase in the step of irradiating light several times even at room temperature.

9. The method for synthesizing a quantum dot of claim 8, wherein the temperature in the step of irradiating light several times exceeds the room temperature.

10. The method for synthesizing a quantum dot of claim 7, wherein the quantum dot is a multi-component quantum dot of at least three components.

11. The method for synthesizing a quantum dot of claim 7, wherein the light is irradiated from a full-wavelength flash lamp.
